(19) United States
(12) Patent Application Publication
(10) Pub. No.: US 2009/0276119 A1
(43) Pub. Date: Nov. 5, 2009

(54) Sump With Controlled Oil Level

(76) Inventors: Charles A. Barker, Danville, IN (US); Walter E. Palmer, Indianapolis, IN (US)

Correspondence Address: ALLISON TRANSMISSION, INC., BARNES & THORNBURG LLP, 11 SOUTH MERIDIAN STREET, INDIANAPOLIS, IN, 46204, US

(21) Appl. No.: 12/113,258

(22) Filed: May 1, 2008

(51) Int. Cl. B60W 10/30; G06F 7/00

(52) U.S. Cl. 701/36; 180/339

(57) ABSTRACT

A motor vehicle having a transmission sump with a controlled oil level is disclosed. The motor vehicle includes a scavenge pump which draws oil from the transmission sump via a scavenge valve. The scavenge valve may be controlled to cause the scavenge pump to draw oil from a selected oil level.

### GOVERNMENTAL NOTICE

This document may contain technical data subject to the international traffic in arms regulation (ITAR) 22 CFR 120-130.

### BACKGROUND

A motor vehicle often includes a transmission that provides a torque-speed conversion from a generally higher speed engine to a slower but more forceful final drive assembly. The final drive assembly may include drive wheels, caterpillar tracks, propels, water jets, etc. that impart the motor vehicle with locomotion when driven by the engine via the transmission. The transmission as well as other components of the motor vehicle may include oil. Oil may be used to lubricate and/or cool components of the motor vehicle such as gears of a transmission. Also, various hydraulic systems of the motor vehicle may contain oil used to control various components of the motor vehicle such as hydraulic solenoids that engage/disengage clutches of the transmission.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a motor vehicle having a power transfer module sump and a transmission sump.

FIGS. 2-3 show details of a scavenge valve used to control an oil level of the transmission sump.

FIG. 4 shows an embodiment of a motor vehicle having a transmission sump and a reservoir.

FIG. 5 shows an embodiment of a method to control the oil level of the transmission sump.

### DESCRIPTION OF THE PREFERRED EMBODIMENT

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

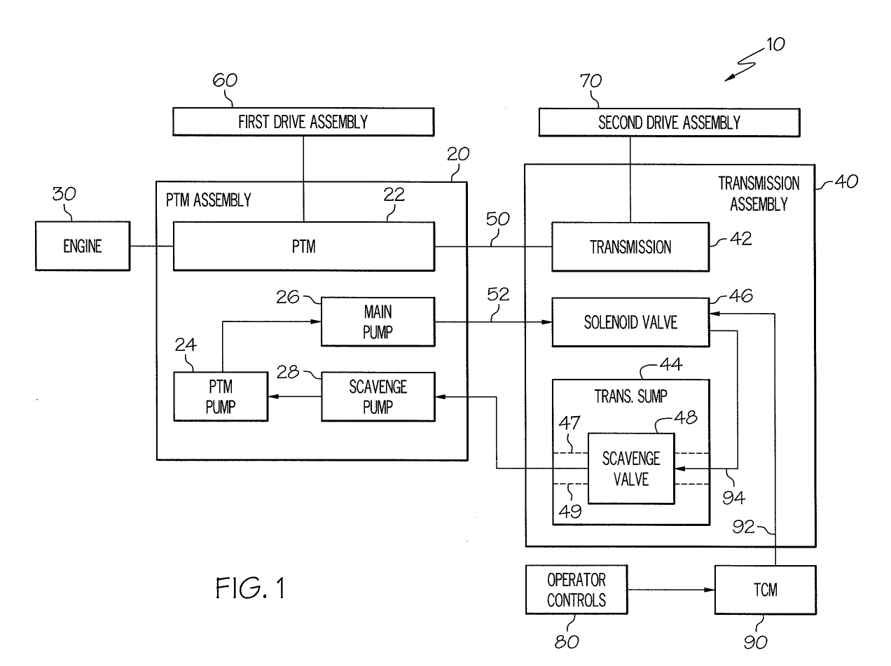

Referring now to FIG. 1, a motor vehicle 10 is shown. The motor vehicle 10 includes a power transfer module assembly 20 coupled to an engine 30. The motor vehicle 10 further includes a transmission assembly 40 coupled to the power transfer module assembly 20 via a drive shaft 50. The motor vehicle 10 also includes a first drive assembly 60 driven by the engine 30 via the power transfer module assembly 20 and a second drive assembly 70 driven by the engine 30 via the transmission assembly 40. In one embodiment, the first drive assembly 60 comprises water jets to propel the motor vehicle 10 across a body of water and the second drive assembly 70 comprises continuous tracks to propel the motor vehicle 10 over land. In other embodiments, the first and second drive assemblies 60, 70 may include other types of drive assemblies such as drive wheels, propels, turbines, and the like.

As shown, the motor vehicle 10 may further include operator controls 80. The operator controls 80 may include various levers, switches, pedals, buttons, wheels, lights, dials, etc. which an operator of the motor vehicle 10 may actuate in order to control operation of the motor vehicle 10 and which an operator may monitor in order to confirm operation of the motor vehicle 10. In one embodiment, the operator controls 80 generate one or more electrical signals which are received by a transmission control module 90. The transmission control module 90 may include various analog and/or digital circuit components which cooperate to control the operation of the power transfer module assembly 20 and the transmission assembly 40. In one embodiment, the transmission control module 90 may include a processor such as a microcontroller or microprocessor and one or more memory devices such as read only memory devices, flash memory device, random access memory devices, and/or other storage devices. The one or memory device may store instructions and data to be executed and processed by the processor of the transmission control module 90.

In response to inputs received from the operator controls 80, the transmission control module 90 may generate control signals to selectively engage/disengage clutches of the power transfer module assembly 20 and transmission assembly 40 to engage the first and or second drive assemblies 60, 70 and to select appropriate gear ratios to drive such drive assemblies 60, 70. Moreover, the transmission control module 90 may generate control signals to selective switch between a first drive mode (e.g. water mode) and a second drive mode (e.g. land mode).

In one embodiment, an operator of the motor vehicle 10, via the operator controls 80, may request the transmission control module 90 to switch from the first drive mode to the second drive mode. In response to such a request, the transmission control module 90 may generate control signals which cause a power transfer module 22 of the power transfer module assembly 20 to disengage the first drive assembly 60 and to engage the drive shaft 50 in order to transfer torque from the engine 30 to transmission 42 and the second drive assembly 70. Similarly, the operator may request the transmission control module 90 to switch from the second drive mode to the first drive mode. In response to such a request, the transmission control module 90 may generate control signals which cause the power transfer module 22 to disengage the drive shaft 50 and to engage the first drive assembly 60 in order to transfer torque from the engine 30 to the first drive assembly 60.

In one embodiment, the power transfer module assembly 20 and transmission assembly 40 share a supply of oil which is used to lubricate moving parts of the power transfer module 22 and transmission 42, to supply fluid for hydraulically actuated clutches, brakes, and valves of the power transfer module 22 and transmission 42, and to cool the power transfer assembly 20 and transmission assembly 40. To this end, the power transfer module assembly 22 includes a sump 24, a main pump 26, and a scavenge pump 28. Similarly, the transmission assembly 40 includes a sump 44, solenoid valve 46, and a scavenge valve 48. Oil used to lubricate the power transfer module 22 collects in the power transfer module sump 24 and oil used to lubricate the transmission 42 collects in the transmission sump 44. The main pump 26 draws oil from the power transfer module sump 24 and transfers the drawn oil to solenoid valve 46 of the transmission assembly 42 via hydraulic line 52. Conversely, the scavenge pump 28 draws oil from the sump 44 of the transmission assembly 40 to the sump 24 of the power transfer assembly 20. In this manner the main pump 26 and scavenge pump 28 circulate oil amongst the power transfer module assembly 20 and the transmission assembly 40.

Components of the power transfer module 22 and transmission 42 such as, for example, gears and clutches may be partially submerged in oil of their respective sumps 24, 44. Thus, the portion such components are submerged increases as the oil level in a sump 24, 44 increases. While the oil helps lubricate and cool such components, the oil also places additional drag upon submerged and/or partially submerged components of the power transfer module 22 and transmission 42 as a result of such components attempting to move through the viscous oil. Accordingly, in order to reduce such drag, the transmission control module 90 in one embodiment generates control signals which cause the scavenge pump 28 via the scavenge valve 48 to lower the oil level in the transmission sump 44 when operating in the second drive mode, and to raise the oil level in the transmission sump 44 when operating in the first drive mode. Since the power transfer module assembly 20 and transmission assembly 40 share the oil supply, it should be appreciated that lowering the oil level in the transmission sump 44 raises the oil level in the power transfer module sump 24, and raising the oil level in the transmission sump 44 lowers the oil level in the power transfer module sump 24.

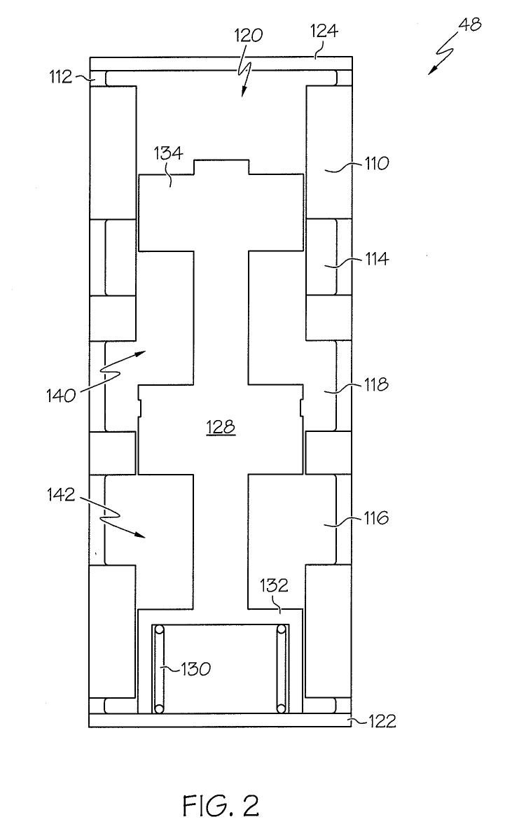

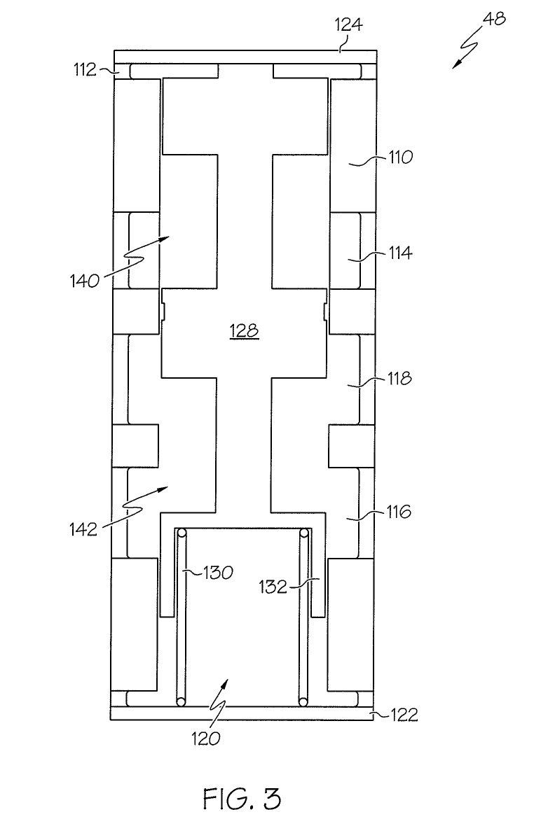

To effectuate such a change in the oil level, the transmission control module 46 in one embodiment selectively generates an electrical control signal 92 to selectively open and close the solenoid valve 46. Based upon the received control signal 92, the solenoid valve 46 provides a hydraulic control signal to the scavenge valve 48 via hydraulic control line 94. As explained in more detail below in regard to FIGS. 2 and 3, the hydraulic control signal determines whether the scavenge valve 48 causes the scavenge pump 28 to draw oil from a high level 47 or from a low level 49 of the transmission sump 44, thus controlling the oil level of the transmission sump 44 and, therefore, the oil level of the power transmission module sump 24.

Referring now to FIGS. 2 and 3, an embodiment of the scavenge valve 48 is shown in a hydraulically activated state (FIG. 2) which results in the scavenge pump 28 drawing oil from the high oil level 47 and a hydraulically deactivated state (FIG. 3) which results in the scavenge pump 28 drawing oil from the low oil level 49. As shown the scavenge valve 48 includes a valve body 110 having solenoid input port 112, a first port 114 associated with the high oil level 47, a second port 116 associated with the low oil level 49, and a scavenge port 118. The valve body 110 may further include a longitudinal bore 120 which runs between a base end 122 and a head end 124 of the valve body 110. The scavenge valve 48 may further include a piston 128 which is slideably positioned within the longitudinal bore 120. A spring 130 may be positioned between a base end 122 of the valve body 110 and a base end 132 of the piston 128. The spring 130 exerts a biasing force against the base end 132 of the piston 128 that biases the piston 128 toward the head end 124 of the valve body 110.

During operation, the solenoid valve 46 may hydraulically control the position of the piston 128 within the bore 120 via a hydraulic line 94 connected to solenoid input port 112. In particular, the transmission control module 90 may generate a control signal 92 to close or partially close the solenoid valve 46 to stop or reduce oil flow through the solenoid valve 46 to the solenoid input port 112 of the scavenge valve 48. As a result of the reduced oil flow to the solenoid input port 112, the spring 130 biases the head end 134 of the piston 128 against the head end 124 of the valve body 110, thus achieving the deactivate position shown in FIG. 3. Conversely, the transmission control module 90 may generate a control signal to open or more fully opening the solenoid valve 46 in order to increase oil flow through the solenoid valve 46 to the solenoid input port 112 of the scavenge valve 48. The increased oil flow creates pressure upon the head end 134 of the piston 130 sufficient to overcome the biasing force of the spring 130. As such, the oil causes base end 132 of the piston 130 to slide toward the base end 122 of the valve body 110, thus achieving the activated position shown in FIG. 2.

As shown in FIGS. 2 and 3, the piston 128 may further include a first channel 140 associated with the high oil level 47 and a second channel 142 associated with the low oil level 49. As shown in FIG. 2, the high oil level channel 140, the low oil level channel 142, and the valve body 110 are configured such that the high oil level channel 140 couples the high oil level port 114 with the scavenge port 118 and that the low oil level channel 142 blocks the low oil level port 116 from the scavenge port 118 when the scavenge valve 48 is activated. Accordingly, when activated, the scavenge valve 48 creates a fluidic path between the high oil level port 114 and the scavenge port 118 while at the same time blocking the low oil level port 116 from the scavenge port 118. Conversely, as shown in FIG. 3, the high oil level channel 140, the low oil level channel 142, and the valve body 110 are further configured such that the high oil level channel 140 blocks the high oil level port 114 from the scavenge port 118 and that the low oil level channel 142 couples the low oil level port 116 to the scavenge port 118 when the scavenge valve 48 is deactivated. Accordingly, when deactivated, the scavenge valve 48 creates a fluidic path between the low oil level port 116 and the scavenge port 118 while at the same time blocking the high oil level port 114 from the scavenge port 118.

In one embodiment, the scavenge valve 48 is placed in the transmission sump 44 in a vertical orientation such that the high oil level port 114 is positioned at a point associated with the desired high oil level 47 and the low oil level port 116 is positioned at a point associated with the desired low oil level 49. In particular, the high oil level port 114 in one embodiment is positioned about 75 mm above the low oil level port 116, thus placing the high oil level 47 about 75 mm above the low oil level 49. However, the scavenge valve 48 in other embodiments may be positioned in other orientations such as horizontally and tubes or other conduits may interface the ports 114, 116 to their respective oil levels.

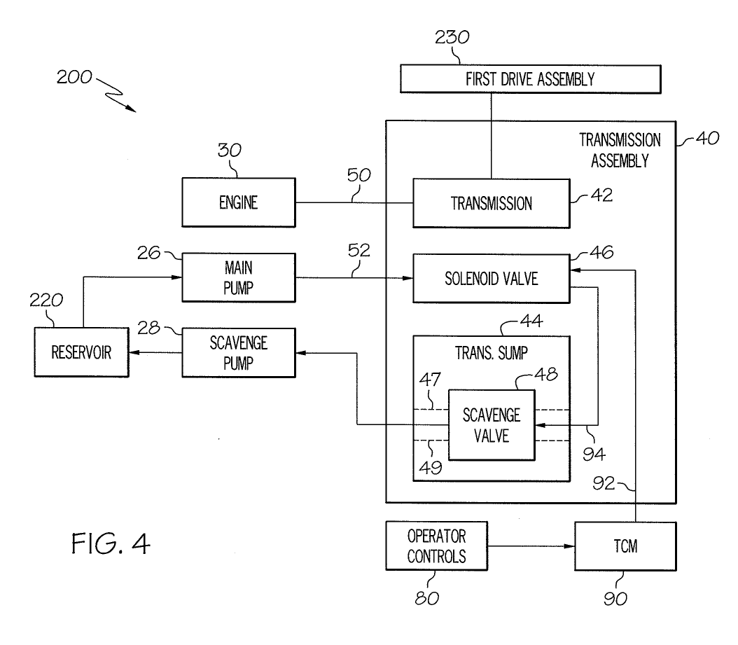

Another embodiment of a motor vehicle 200 is shown in FIG. 4. Components of motor vehicle 200 have been labeled with the same reference numerals as similar components of motor vehicle 10 of FIG. 1. As shown, the engine 30 of motor vehicle 200 is coupled to the transmission 42 via drive shaft 50 without the intervening power transfer module 22 of motor vehicle 10. Furthermore, the power transfer module sump 24 has been replace with a reservoir 220, and the separate drive assemblies 60, 70 have been replaced with a single final drive assembly 230.

In the embodiment shown in FIG. 4, the transfer control module 90 may selectively activate the solenoid valve 46 to raise or low the oil level in the transmission sump 44 in response to requests received via the operator controls 80. For example, the operator may request a first mode of operation (e.g. high power mode) which results in the lowering of the oil level, or a second mode of operation (e.g. normal mode) which results in the raising of the oil level. Moreover, the transfer control module 90 may selectively activate the solenoid valve 46 based upon various sensors (not shown). For example, the transfer control module 90 may determine to raise the oil level in response to a temperature sensor indicating the components of the transmission 42 are overheating.

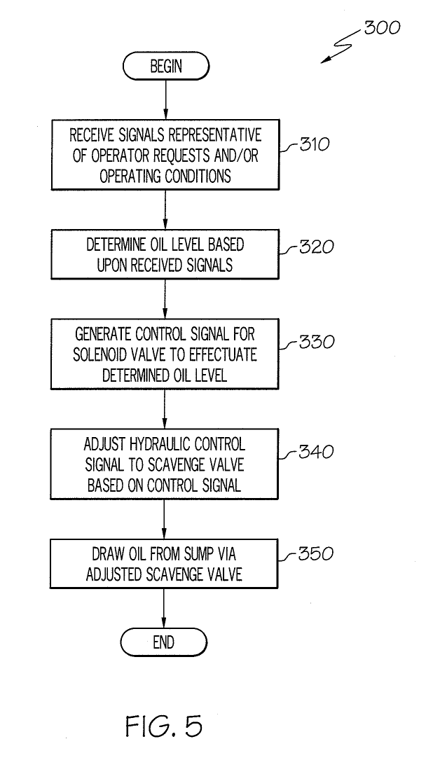

Turning now to FIG. 5, an embodiment of a variable oil level control method 300 is shown. As shown, the transmission control module 90 at block 310 may receive signals representative of operator requests and/or operating conditions of the motor vehicle 10, 200. At block 320, the transmission control module 90 may select an oil level for the sump 44 from a plurality of supported oil levels (e.g. high oil level 47 and low oil level 49) based upon the received signals. The transmission control module 90 at block 330 may generate a control signal for the solenoid valve 46 in order to effectuate the selected oil level. In one embodiment, if the transmission control module 90 selects the high oil level 47, then the transmission control module 90 may generate the control signal 92 such that the solenoid valve 46 opens. Conversely, if the transmission control module 90 selects the low oil level 49 for the sump 44, then the transmission control module 90 may generate the control signal 92 such that the solenoid valve 46 closes.

In response to the received control signal, the solenoid valve 46 may adjust the scavenge valve 48 to obtain the selected oil level at block 340. In particular, the solenoid valve 46, in response to being opened by the control signal 92, may supply oil to the solenoid input port 112 of the scavenge valve 48 in order to couple the high oil level port 114 of the scavenge valve 48 to the scavenge port 118. Conversely, the solenoid valve 46, in response to being closed by the control signal 92, may reduce or shut off oil supplied to the solenoid input port 112 of the scavenge valve 48 in order to couple the low oil level port 116 of the scavenge valve 48 to the scavenge port 118. Finally, at block 350, the scavenge pump 28 may draw oil from the transmission sump 44 via the scavenge port 118, and thus the previously selected high oil level port 114 or low oil level port 116.

In the above described embodiments, opening the solenoid valve 46 has been associated with the high oil level 47 and closing the solenoid valve 46 has been associated with the low oil level 49. However, the solenoid valve 46 and/or scavenge valve 48 in other embodiments may be implemented such that opening the solenoid valve 46 is instead associated with the low oil level 49 and closing the solenoid valve 46 is associated with the high oil level 47. Similarly, in the above describe embodiments, activating the scavenge valve 48 has been associated with the high oil level 47 and deactivating the scavenge valve 48 has been associated with the low oil level 49. However, the scavenge valve 48 in other embodiments may be implemented such that activating the scavenge valve 48 is instead associated with the low oil level 49, and deactivating the scavenge valve is associated with the high oil level 47. Furthermore, while the scavenge valve 48 has been disclosed with two oil level ports 114, 116, the scavenge valve 48 in other embodiments may include additional oil level ports in order to support several distinct oil levels.

While the disclosure has been illustrated and described in detail in the drawings and foregoing description, such an illustration and description is to be considered as merely illustrative and not restrictive in character, it being understood that only illustrative embodiments have been shown and described and that all changes and modifications that come within the spirit of the disclosure are desired to be protected.

What is claimed is:

1. A method, comprising
selecting from a plurality of oil levels, based upon one or more signals, an oil level for a transmission sump associated with a transmission that transfers engine torque to a final drive assembly, and
pumping oil from a point of the transmission sump that is associated with the selected oil level.

2. The method of claim 1, further comprising
pumping oil from a reservoir to the transmission sump,
wherein the pumping oil from a point of the transmission sump comprises pumping oil to the reservoir from the point associated with the selected oil level.

3. The method of claim 1, further comprising
pumping oil from a power transfer module assembly that selectively transfers engine torque to another final drive assembly and the transmission,
wherein pumping oil from the transmission sump further comprises pumping oil from the point associated with the selected oil level to the power transfer module assembly.

4. The method of claim 1, further comprising receiving the one or more signals in response to a request from an operator, the one or more signals indicative of the request.

5. The method of claim 1, further comprising
pumping oil from a power transfer module assembly that selectively transfers engine torque to another final drive assembly and the transmission, and
receiving the one or more signals, the one or more signals indicative of a request from an operator to transfer engine torque to the transmission instead of the another final drive assembly, wherein
the selecting comprises selecting a low oil level that is lower than a high oil level in response to receiving the one or more signals, and
the pumping oil from the point of the transmission associated with the selected oil level comprises pumping oil from the low oil level to the power transfer module assembly.

6. The method of claim 1, further comprising
pumping oil from a power transfer module assembly that selectively transfers engine torque to another final drive assembly and the transmission, and
receiving the one or more signals, the one or more signals indicative of a request from an operator to transfer engine torque to the another final drive assembly instead of the transmission, wherein
the selecting comprises selecting a high oil level that is higher than a low oil level in response to receiving the one or more signals, and
the pumping oil from the point of the transmission associated with the selected oil level comprises pumping oil from the high oil level to the power transfer module assembly.

7. A motor vehicle, comprising an engine, first drive assembly, second drive assembly, power transfer module assembly, transmission assembly, and a transmission control module, wherein
the transmission assembly comprises a transmission to transfer engine torque received via the power transfer module to the second drive assembly, a transmission sump to receive oil, and a scavenge valve coupled to the scavenge pump, the scavenge valve having a plurality of ports selectively coupled to a scavenge port of the scavenge valve to permit drawing oil from a plurality of corresponding oil levels of the transmission sump,
the power transfer module assembly comprises a power transfer module to selectively transfer torque from the engine to the first drive assembly and the transmission, a scavenge pump coupled to the scavenge port of the scavenge valve to pump oil from the transmission sump at a point associated with the selected port of the scavenge valve, a main pump to pump oil to the transmission assembly, and a power transfer module sump to receive oil scavenged from the transmission assembly, and
the transmission control module selects an oil level for the transmission sump and generates one or more control signals to selectively couple to the scavenge port a port of the plurality of ports associated with the selected oil level.

8. The motor vehicle of claim 7, wherein the first drive assembly imparts locomotion over water and the second drive assembly imparts locomotion over land.

9. The motor vehicle of claim 7, wherein the first drive assembly comprises one or more water jets to impart locomotion over water and the second drive assembly comprises one or more continuous tracks to impart locomotion over land.

10. The motor vehicle of claim 9, wherein
the plurality of ports of the scavenge valve include a first port associated with a high oil level and a second port associated with a low oil level that is lower than the high oil level, and
the transmission control module selects the high oil level in response to causing the power transfer module to transfer torque from the engine to the first drive assembly instead of the transmission.

11. The motor vehicle of claim 9, wherein
the plurality of ports of the scavenge valve include a first port associated with a high oil level and a second port associated with a low oil level that is lower than the high oil level, and
the transmission control module selects the low oil level in response to causing the power transfer module to transfer torque from the engine to the transmission instead of the first drive assembly.

12. The motor vehicle of claim 7, wherein the transmission assembly further comprises a solenoid valve to hydraulically control the scavenge valve based upon an electronic control signal received from the transmission control module.

13. A system, comprising
a transmission to transfer engine torque to a final drive assembly,
a transmission sump to receive oil,
a scavenge valve comprising a scavenge port, a plurality of ports corresponding to a plurality of oil levels in the transmission sump, and a control input, the scavenge valve to selectively couple the plurality of ports to the scavenge port based upon a hydraulic control signal received via the control input,
a solenoid valve to provide the hydraulic control signal based upon a received electrical control signal, and
a control module to select an oil level for the transmission sump and to provide the solenoid valve with an electrical control signal that results in the solenoid valve coupling a port of the plurality of ports associated with the selected oil level the scavenge port.

14. The system of claim 13, further comprising
a reservoir,
a scavenge pump coupled to the scavenge port of the scavenge valve to pump oil to the reservoir from the transmission sump at a point associated with the selected port of the scavenge valve, and
a main pump to pump oil from the reservoir to transmission sump via the solenoid valve.

15. The system of claim 13, further comprising
a power transfer module to selectively transfer engine torque to another final drive assembly and the transmission,
a power transfer module sump to receive oil that lubricates the power transfer module,
a scavenge pump coupled to the scavenge port of the scavenge valve to pump oil to the power transfer module sump from the transmission sump at a point associated with the selected port of the scavenge valve, and
a main pump to pump oil from the reservoir to transmission sump via the solenoid valve.

16. The motor vehicle of claim 15, wherein
the plurality of ports of the scavenge valve include a first port associated with a high oil level and a second port associated with a low oil level that is lower than the high oil level, and
the transmission control module selects the high oil level in response to causing the power transfer module to transfer torque from the engine to the another final drive assembly instead of the transmission.

17. The motor vehicle of claim 15, wherein
the plurality of ports of the scavenge valve include a first port associated with a high oil level and a second port associated with a low oil level that is lower than the high oil level, and
the transmission control module selects the low oil level in response to causing the power transfer module to transfer torque from the engine to the transmission instead of the another final drive assembly.
